(19) United States
(12) Patent Application Publication
(10) Pub. No.: US 2007/0159045 A1
(43) Pub. Date: Jul. 12, 2007

(54) Backlight unit of LCD

(76) Inventor: Joon Seok Ahn, Suwon-si (KR)

Correspondence Address: MCKENNA LONG & ALDRIDGE LLP;Song K. Jung, 1900 K Street, N.W., Washington, DC, 20006, US

(21) Appl. No.: 11/474,355

(22) Filed: Jun. 26, 2006

(30) Foreign Application Priority Data
Dec. 27, 2005 (KR) 10-2005-0130776

(51) Int. Cl. H01J 5/16

(52) U.S. Cl. 313/116

(57) ABSTRACT

This invention relates to a backlight unit that diffuses light irradiated from lamps to a liquid crystal display panel twice. A backlight unit of a liquid crystal display device according to an embodiment of the present invention includes a plurality of lamps that irradiate light to a liquid crystal display panel; a plurality of diffusion sheets disposed on the lamps; and a diffusion plate between the plurality of diffusion sheets and the liquid crystal display panel.

This application claims the benefit of Korean Patent Application No. P2005-0130776, filed on Dec. 27, 2005 which is hereby incorporated by reference for all purposes as if fully set forth herein.

### BACKGROUND OF THE INVENTION

1. Field of the Invention

The present invention relates to a liquid crystal display device, and more particularly to a backlight unit for diffusing the light irradiated from lamps to a liquid crystal display panel twice.

2. Discussion of the Related Art

Generally, liquid crystal display devices are being more widely used due to their light weight, thin profile, low power consumption, etc. Because of these, the liquid crystal display device is used in office automation equipment, audio/video equipment, etc. The liquid crystal display device controls the transmitted amount of light irradiated from a backlight unit in accordance with a signal applied to a plurality of control switches that are arranged in a matrix, thereby displaying a desired picture on a screen.

In this way, the liquid crystal display device is not a self luminous display device, thus it requires a separate light source such as a backlight.

The backlight may be classified as a direct type and an edge type in accordance with the location of a light source. The edge type backlight has a light source installed at the edge of one side of a liquid crystal display device, and irradiates light from the light source to a liquid crystal display panel through a light guide panel and a plurality of optical sheets. The direct type backlight has a plurality of light sources disposed right under the liquid crystal display device, and irradiates light from the light sources to the liquid crystal display panel through a diffusion plate and a plurality of optical sheets.

The direct type backlight, which has better brightness, light uniformity and color purity than those of the edge type backlight, is more often used in LCD TVs.

Referring to FIG. 1, a liquid crystal display device according to the related art includes a liquid crystal display panel 11 for displaying a picture, and a backlight unit 10 for irradiating light to the liquid crystal display panel 11.

In the liquid crystal display panel 11, a plurality of data lines cross a plurality of scan lines, and liquid crystal cells are arranged in a matrix between upper and lower substrates. Further, in the liquid crystal display panel, pixel electrodes and a common electrode are formed for applying an electric field to each of liquid crystal cells. Thin film transistors (hereinafter, referred to as ‘TFT’) for switching a data voltage applied to the pixel electrode in response to a scan signal are formed at the crossing of the data lines and the scan lines. In the liquid crystal display panel, gate drive integrated circuits (hereinafter, referred to as ‘IC’) are electrically connected to data drive ICs through a tape carrier package (hereinafter, referred to as ‘TCP’).

The backlight unit 10 includes a plurality of lamps 15; a bottom cover 12; a diffusion plate 13 and a plurality of optical sheets 14.

The lamps 15 are powered by an AC high voltage from an inverter (not shown), thereby radiating the light onto the diffusion plate 13.

The bottom cover 12 is made in a container structure where the lamps 15 are put in an inner space thereof, and the reflection plate is formed in the bottom surface and side surface of the inner space.

The diffusion plate 13 is assembled together with the bottom cover 12. The diffusion plate 13 includes a plurality of beads and disperses the light incident through the lamps 15 by use of the beads so that no brightness difference occurs between locations of lamps 15 and locations between lamps 15 in the display surface of the liquid crystal display panel 11. The diffusion plate 13 is made to have a structure where the beads are scattered in a medium having the same refractive index, thus the light can not be condensed.

The optical sheets 14 include one or more diffusion sheet 14A and one or more prism sheet 14B, as shown in FIG. 2, and act to condense the light to the front of a display surface by uniformly irradiating the light incident from the diffusion plate 13 to the whole liquid crystal display panel 11 and bending the path of the light in a vertical direction to the display surface.

But, recently, HCFL lamps with high brightness have been used in the backlight unit 10, thus there is generated a mural phenomenon such that the locations of the lamps are exposed on the screen when using only one diffusion plate 13, hereby the quality of the screen is deteriorated.

### SUMMARY OF THE INVENTION

Accordingly, the present invention is directed to a backlight unit of an LCD that substantially obviates one or more of the problems due to limitations and disadvantages of the related art.

An advantage of the present invention is to provide a backlight unit of a liquid crystal display device that diffuses the light irradiated from lamps to a liquid crystal display panel twice.

Another advantage of the present invention is to provide a backlight unit of a liquid crystal display device that prevents a mural phenomenon, where a location of a lamp is exposed on a screen, by diff-using the light irradiated from the lamps to the liquid crystal display panel twice.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

An advantage of the present invention is to provide a backlight unit of a liquid crystal display that includes a plurality of lamps that irradiate light to a liquid crystal display panel; a plurality of diffusion sheets disposed on the lamps; and a diffusion plate between the plurality of diffusion sheets and the liquid crystal display panel.

Another advantage of the present invention is to provide a backlight unit of a liquid crystal display device that includes: a plurality of lamps for irradiating light to a liquid crystal display panel; a plurality of diffusion covers disposed on the lamps; a diffusion plate located between the diffusion covers and the liquid crystal display panel; and a lower side bottom and an upper side bottom that fixes the diffusion covers on the lamps.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross sectional view of a liquid crystal display device of the related art;

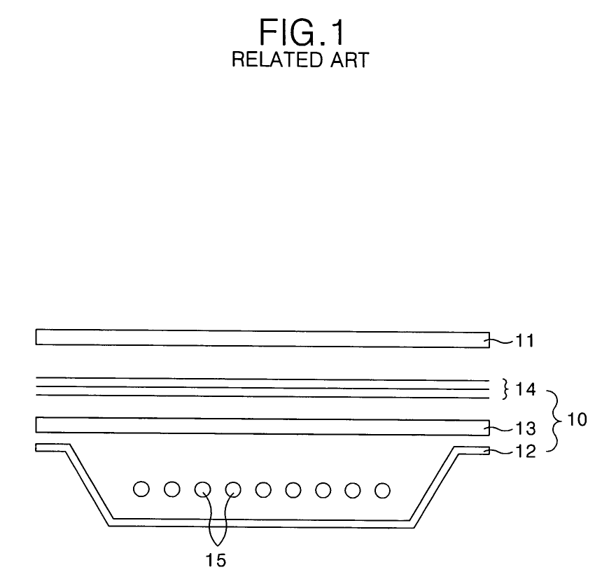

FIG. 2 is a cross sectional view representing a configuration of optical sheets shown in FIG. 1;

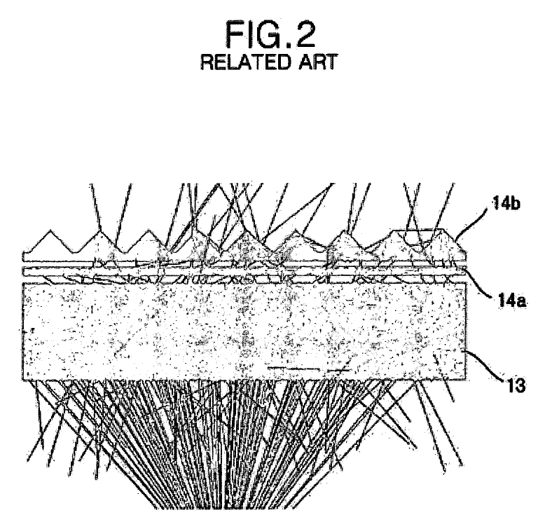

FIG. 3 is a perspective plan view of a backlight unit of a liquid crystal display device according to an embodiment of the present invention;

FIG. 4 is a perspective plan view of a lamp to which a diffusion sheet is stuck according to the embodiment of the present invention;

FIG. 5 is a cross sectional view of a backlight unit of the liquid crystal display device according to the embodiment of the present invention;

FIG. 6 is an exploded perspective plan view of a backlight unit of a liquid crystal display device according to another embodiment of the present invention;

FIG. 7 is a combination perspective view of the backlight unit of the liquid crystal display device according to the another embodiment of the present invention; and

FIG. 8 is a cross sectional view of the backlight unit of the liquid crystal display device according to the another embodiment of the present invention.

### DETAILED DESCRIPTION OF THE ILLUSTRATED EMBODIMENTS

Reference will now be made in detail to an embodiment of the present invention, example of which is illustrated in the accompanying drawings.

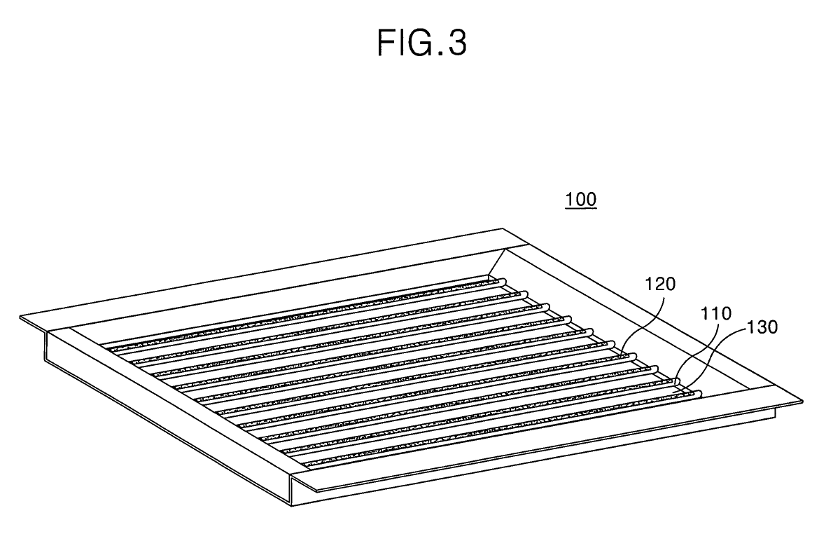

With reference to FIGS. 3 to 8, embodiments of the present invention will be explained as follows.

FIG. 3 is a perspective plan view of a backlight unit of a liquid crystal display device according to an embodiment of the present invention, and only illustrates a diffusion plate, a diffusion sheet and a lamp in order to clearly show the characteristics of the present invention.

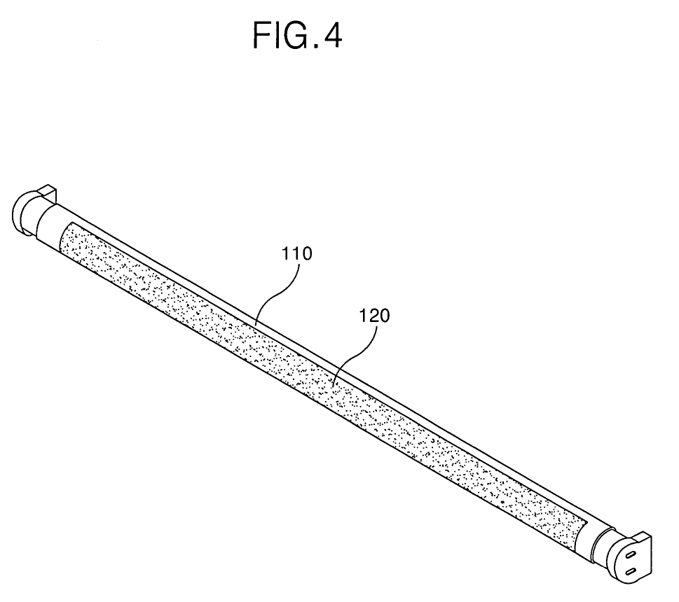

FIG. 4 is a perspective plan view of a lamp to which a diffusion sheet is attached according to the embodiment of the present invention.

Referring to FIG. 3, a backlight unit 100 according to an embodiment of the present invention includes: a plurality of lamps 110 for irradiating the light, which determines the brightness of a screen, to a liquid crystal display panel (not shown) of the liquid crystal display device; a diffusion sheet 120 for difflusing the light generated from the lamps 110 to the liquid crystal display panel; and a reflection plate 130 for reflecting the light irradiated from the lamps 110 to the liquid crystal display panel.

The diffusion sheet 120 performs the function of diffusing the light generated from the lamps 110 to the liquid crystal display panel, like the diffusion plate (not shown). But, the diffusion sheet 120 is directly attached to the lamp 110, thus the diffusion sheet may be made of polymethyl methacrylate (PMMA) that is heat-resistant so as to bear the heat of the lamp 110. Herein, the diffusion plate is disposed between the liquid crystal display panel and the lamps 110 to which the diffusion sheet 120 is attached.

The diffusion sheet 120 may be adhered to the lamp 110 by a heat-resistive transparent adhesive, and especially in the present invention as shown in FIG. 4, the diffusion sheet 120 only covers half of the body of the lamp 110 in a cylindrical lamp body, and the diffusion sheet 120 is adhered to the front of the lamp nearest to the liquid crystal display panel. Of course, the method of adhering the diffusion sheet 120 to the lamp 110 is not limited to this method.

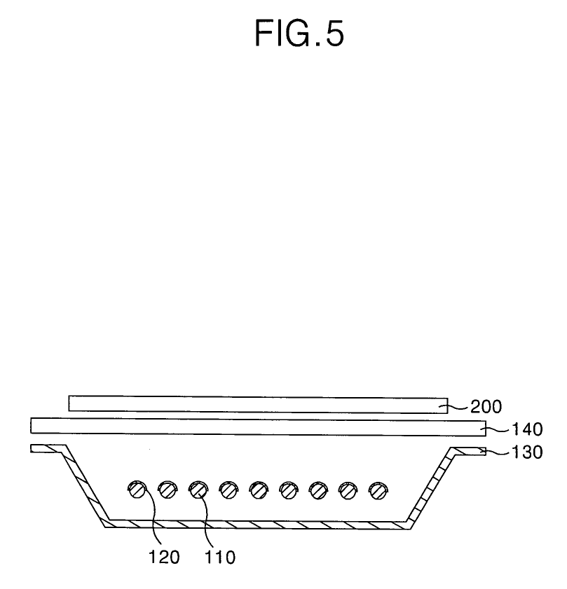

In this way, when the diffusion sheets 120 are adhered to the lamps 110, a cross section of the backlight unit according to this embodiment of the present invention is illustrated as in FIG. 5.

FIG. 5 is a cross sectional view of the backlight unit of the liquid crystal display device according to an embodiment of the present invention.

Referring to FIG. 5, in the backlight unit 100 according to the embodiment of the present invention, a reflection plate 130, a plurality of lamps 110 aligned in series along a horizontal direction, a plurality of diffusion sheets 120 attached to the lamps 110 respectively, and a diffusion plate 140 are sequentially disposed. A liquid crystal display panel 200 is disposed to be separated from the diffusion plate 140.

The present invention results in the diffusion sheet 120 and the diffusion plate 140 providing a double diffusion layer between the lamps 110 and the liquid crystal display panel 200, thereby diffusing the light twice so that the locations of the lamps 110 are not exposed on a screen. Accordingly, it is desirable that the length of the diffusion sheet 120 is not longer than the lamps 110 and has the same horizontal length as the liquid crystal display panel 200.

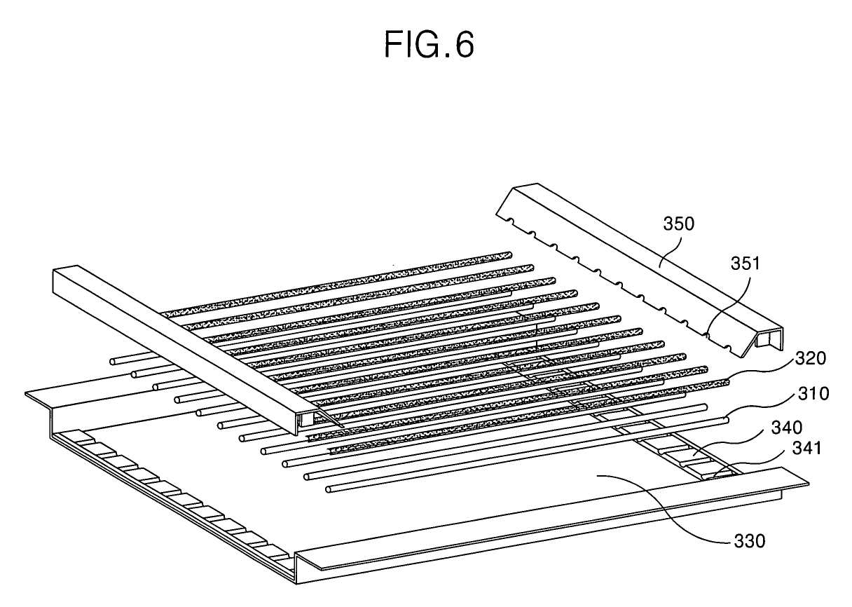

FIG. 6 is an exploded perspective plan view of a backlight unit of a liquid crystal display device according to another embodiment of the present invention and only illustrates a diffusion plate, a diffusion cover and a lamp in order to clearly show the characteristics of the present invention.

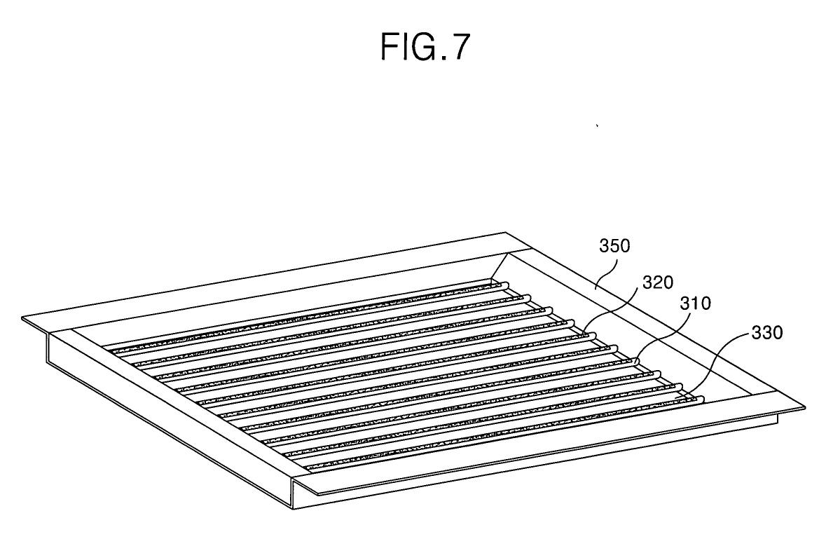

FIG. 7 is a combination perspective view of a backlight unit of a liquid crystal display device according to the another embodiment of the present invention.

Referring to FIG. 6, a backlight unit 300 according to another embodiment of the present invention includes: a plurality of lamps 310 for irradiating light, which determines the brightness of the screen, to the liquid crystal display panel; diffusion covers 320 for diffusing the light generated from the lamps 310 to the liquid crystal display panel; and a reflection plate 330 for reflecting the light irradiated from the lamps 310 to the liquid crystal display panel.

The diffusion cover 320 performs the function of diffusing the light generated from the lamps 310 to the liquid crystal display panel. But, the diffusion cover 320 is attached to the lamp 310, thus the diffusion cover may be made of a heat-resistive material that can bear the heat of the lamp 310. Herein, the diffusion plate is disposed between the liquid crystal display panel and the diffusion covers 320.

A lower side bottom 340 for supporting and fixing the lamps 310 is attached to both side ends of the reflection plate 330, and a plurality of lower holders 341 for securely placing the lamps 310 are formed to be separated from each other with a fixed gap on the lower side bottom 340.

The lamps 310 securely placed in the lower holders 341 formed in the lower side bottom 340 are fixed by an upper side bottom 350. A plurality of upper holders 351 are formed in the upper side bottom 350, and the upper holders 351 are formed in locations corresponding to the lower holders 341 in a one-to-one relationship when the lower side bottom 340 with the upper side bottom 350 are combined. Accordingly, the lamp 310 is located between the lower holder 341 and the upper holder 351 when the lamp 310 is fixed by the lower side bottom 340 and the upper side bottom 350.

An assembly process of fixing the lamp 310 and the diffusion cover 320 by use of the lower side bottom 340 and upper side bottom 350 having such a structure is described as follows.

First, the diffusion cover 320 is made separately from the lamp 310, and then the lamp 310 is securely placed in the lower holder 341 formed in the lower side bottom 340. The diffusion cover 320 is placed on the lamp 310 after the lamp 310 is securely placed in this way, and both ends of the lamp 310 are placed on the lower holder 341 at both sides of the reflection plate 330.

The upper side bottom 350 is combined with the lower side bottom 340 after the lamp 310 is securely placed in the lower holder 341, and the upper holders 351 are placed over the lamps 310 with the diffusion covers 320. That is to say, the lamp 310 and the diffusion cover 320 are fixed onto the reflection plate 330 by the lower side bottom 340 and upper side bottom 350.

As shown in the diagram, in the present invention, the diffusion cover 320 only covers half of the cylindrical body of the lamp 310, and the diffusion cover 320 is located in a front direction being the liquid crystal display panel direction. Especially, the diffusion cover 320 is desirable to be realized of a heat-resistive transparent material.

In this way, when the diffusion covers 320 are respectively fixed to the reflection plate 330 together with the lamps 310.

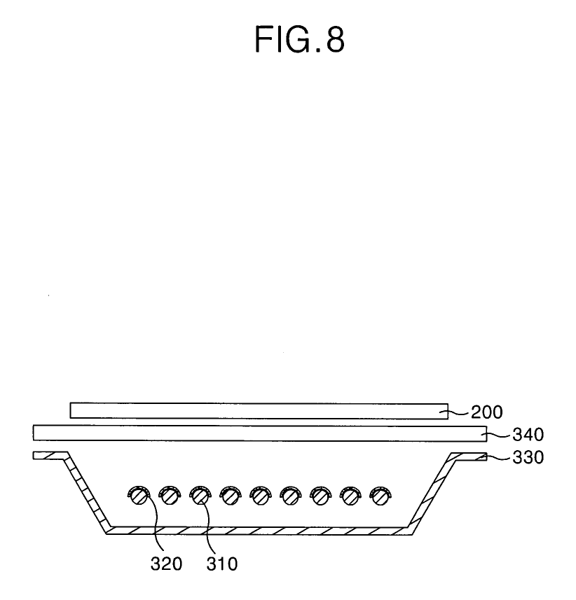

FIG. 8 is a cross sectional view of the backlight unit of the liquid crystal display device according to another embodiment of the present invention.

Referring to FIG. 8, in the backlight unit 300 a reflection plate 330, a plurality of lamps 310 aligned in series along a horizontal direction, a plurality of diffusion covers 320 located on the lamps 310 respectively, and a diffusion plate 340 are sequentially disposed. A liquid crystal display panel 200 is disposed over the diffusion plate 340.

The present invention results in the diffusion cover 320 and the diffusion plate 340 providing a double diffusion layer between the lamps 310 and the liquid crystal display panel 200, thereby diffusing the light twice so that the locations of the lamps 310 are not exposed on screen.

As described above, the present invention diffuses the light irradiated from the lamp to the liquid crystal display panel twice by use of the diffusion sheet or diffusion cover and the diffusion plate, so as to prevent the mural phenomenon where the location of the lamp is exposed on the screen, thereby improving the quality of the screen.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A backlight unit of a liquid crystal display device, comprising:
a plurality of lamps that irradiate light to a liquid crystal display panel;
a plurality of diffusion sheets disposed on the lamps; and
a diffusion plate between the plurality of diffusion sheets and the liquid crystal display panel.

2. The backlight unit according to claim 1, wherein the diffusion sheets are adhered to the lamps.

3. The backlight unit according to claim 2, wherein the diffusion sheets are adhered to the lamps by a heat-resistive transparent adhesive.

4. The backlight unit according to claim 3, wherein the diffusion sheet is adhered to only a part of the body of the lamp and is located on a side of the lamp nearest to the liquid crystal display panel.

5. The backlight unit according to claim 1, wherein the diffusion sheet is made from polymethyl methacrylate.

6. The backlight unit according to claim 1, wherein a length of the diffusion sheet is not shorter than a horizontal length of the liquid crystal display panel.

7. A backlight unit of a liquid crystal display device, comprising:
a plurality of lamps for irradiating light to a liquid crystal display panel;
a plurality of diffusion covers disposed on the lamps;
a diffusion plate located between the diffusion covers and the liquid crystal display panel; and
a lower side bottom and an upper side bottom that fixes the diffusion covers on the lamps.

8. The backlight unit according to claim 7, wherein the diffusion cover on only part of the body of the lamp and is located on a side of the lamp nearest to the liquid crystal display panel.

9. The backlight unit according to claim 8, wherein the diffusion cover is made from a heat-resistive transparent material.

10. A method of assembling a backlight unit of a liquid crystal display device, comprising:
placing a plurality of lamps that irradiate light to a liquid crystal display panel in a reflection plate;
placing a plurality of diffusion sheets on the lamps; and
placing a diffusion plate between the plurality of diffusion sheets and the liquid crystal display panel.

11. The method of claim 10, wherein the diffusion sheets are adhered to the lamps.

12. The method of claim 11, wherein the diffusion sheets are adhered to the lamps by a heat-resistive transparent adhesive.

13. The method of claim 10, wherein the diffusion sheet is adhered to only a part of the body of the lamp and is located on a side of the lamp nearest to the liquid crystal display panel.

14. The method of claim 10,wherein the diffusion sheet is made from polymethyl methacrylate.

15. A method of assembling a backlight unit of a liquid crystal display device, comprising:
placing a plurality of lamps for irradiating light to a liquid crystal display panel in a reflection plate;
placing a plurality of diffusion covers on the lamps;
placing a diffusion plate between the diffusion covers and the liquid crystal display panel; and
placing a lower side bottom and an upper side bottom to fix the diffusion covers on the lamps.

16. The method of claim 15, wherein the diffusion sheet is adhered to only a part of the body of the lamp and is located on a side of the lamp nearest to the liquid crystal display panel.
